(19) United States
(12) Patent Application Publication
(10) Pub. No.: US 2005/0020143 A1
(43) Pub. Date: Jan. 27, 2005

(54) Electrical terminal assembly, particularly for an electric heater

(76) Inventor: Peter Brian Ross, Gnosall (GB)

Correspondence Address: Ira S. Dorman;Suite 200, 330 Roberts Street, East Hartford, CT, 06108, US

(21) Appl. No.: 10/891,539

(22) Filed: Jul. 15, 2004

(30) Foreign Application Priority Data
Jul. 19, 2003 (GB) 0316971.1

(51) Int. Cl. H01R 9/22

(52) U.S. Cl. 439/709

(57) ABSTRACT

An electrical terminal assembly (14) comprises an attachment member (16) adapted to be secured a support (4) and an elongate tubular metal member (24) of predetermined length. The tubular member has first and second ends (26, 30) and is secured at the first end (26) thereof to the attachment member (16) and extends outwardly therefrom. An electrically conductive lead member (32) extends through the elongate tubular metal member (24) and has a first end (32A) extending from the first end (26) of the elongate tubular metal member (24) and a second end (32B) thereof extending from the second end (30) of the elongate tubular metal member (24); and heat-withstanding electrical insulation means (44), in the form of compacted pulverulent material, provided within the elongate tubular metal member (24) between the electrically conductive lead member (32) and the elongate tubular metal member.

This invention relates to an electrical terminal assembly, which terminal assembly is particularly adapted for an electric heater. Such an electric heater may be a heater for use in a cooking appliance.

### DESCRIPTION OF PRIOR ART

It is known to provide an electric heater comprising a dish-like support, such as of metal, having provided therein at least one electric heating element. The heating element or elements may be of radiant form and comprising electrical resistance heating means. The heating element or elements is or are known to be supported relative to a layer of thermal and electrical insulation material provided in the dish-like support. A particularly advantageous material for the heating element or elements is a metal ribbon, which may be corrugated and which is suitably supported edgewise on the base layer of insulation material.

In order to electrically connect such an electric heater to a power supply by means of lead wires, and possibly by way of control means, it is known to provide a terminal block at a periphery of the heater. A known form of terminal block comprises a ceramic member, which is secured at an apertured region of the periphery of the heater and is provided with one or more electrically conductive components of relatively short length extending therethrough. It is known to electrically connect termination regions of a heating element, such as of ribbon form, directly to one end of the electrically conductive components of the terminal block inside the heater, such as by welding. Electrical terminals, such as of pin or spade form, are provided at the other end of the electrically conductive components of the terminal block outside the heater and in close proximity to the terminal block. Such electrical terminals are arranged to be electrically connected to external lead wires leading directly or indirectly to a power supply.

A problem exists in that considerable heat from the heating element or elements is conducted along the relatively short electrically components in the terminal block to the electrical terminals outside the terminal block, resulting in an unacceptably high temperature at these terminals.

Furthermore, the close proximity of the terminals to the terminal block results in lack of flexibility in making external electrical connections thereto, particularly when different numbers of terminals are required to be accommodated.

### OBJECT OF THE INVENTION

It is an object of the present invention to overcome or minimise these problems.

### SUMMARY OF THE INVENTION

According to one aspect of the present invention there is provided an electrical terminal assembly comprising: an attachment member adapted to be secured to a support; an elongate tubular metal member of predetermined length, having first and second ends, secured at the first end thereof to the attachment member and extending outwardly therefrom; and an electrically conductive lead member extending through the elongate tubular metal member, the electrically conductive lead member having a first end thereof extending from the first end of the elongate tubular metal member, and a second end thereof extending from the second end of the elongate tubular metal member; and heat-withstanding electrical insulation means, in the form of compacted pulverulent material, provided within the elongate tubular metal member between the electrically conductive lead member and the elongate tubular metal member.

The attachment member may be provided with an aperture therethrough for securely receiving the first end of the elongate tubular metal member.

The attachment member may be of strip or plate form and may comprise metal, such as steel, which may be of stainless form or plated with another metal.

The elongate tubular metal member may be secured at the first end thereof to the attachment member by welding, brazing or swaging.

The pulverulent material may comprise at least one inorganic oxide material, such as magnesium oxide.

Alternatively or additionally, the electrically conductive lead member may be supported within the elongate tubular metal member by means of a bead of ceramic material provided in the region of each end of the lead member. The bead of ceramic material may be of “top hat” form and inserted into the end of the tubular member.

The electrically conductive lead member may be of metal rod or thick wire form and may be selected from a ferrous based chromium alloy, a nickel chromium alloy and nickel.

The first end of the electrically conductive lead member may be of flattened form, for example to be welded to a termination region of an electric heating element.

The second end of the electrically conductive lead member may be provided with electrical terminal means, such as of pin or spade-like form, adapted for example for interfacing with external electrical connection lead means.

The predetermined length of the elongate tubular metal member may be selected such that a required low temperature and/or a required location or disposition of the second end of the electrically conductive lead member is obtained.

The elongate tubular metal member may be of straight, curved, bent or angled form and may comprise steel, which may be of stainless form, or plated with another metal such as copper.

A plurality of the elongate tubular metal members may be provided, secured for example in side-by-side arrangement to the attachment member. Such plurality of the elongate tubular metal members may be disposed substantially parallel to one another.

According to another aspect of the present invention there is provided an electric heater comprising a dish-like support in which is provided at least one electric heating element, and a terminal assembly as hereinbefore defined secured to the dish-like support and electrically connected to a termination region of the electric heating element.

The dish-like support of the heater may incorporate an apertured upstanding peripheral rim to which the attachment member is secured.

The dish-like support may comprise metal.

The dish-like support may comprise or be provided with a base layer of thermal and electrical insulation material relative to which is supported the at least one electric heating element.

The attachment member may be secured to the dish-like support by threaded fastener means or clip means, or by welding or brazing.

The at least one electric heating element may be at least one electrical resistance heating element, which may be of radiant form and which may comprise at least one metal ribbon.

The electric heater may be for use in a cooking appliance.

By means of the present invention, an electrical terminal assembly is provided, which has one or more terminals arranged for connection to external connection leads, such terminals being at a satisfactorily low temperature. The electrical terminal assembly of the present invention also exhibits advantageous versatility with regard to the location, spacing and number of terminals which can be provided.

For a better understanding of the present invention and to show more clearly how it may be carried into effect, reference will now be made, by way of example, to the accompanying drawings in which:

### BRIEF DESCRIPTION OF THE DRAWINGS

FIG. 1 is a perspective view of an electric heater provided with an embodiment of an electrical terminal assembly according to the present invention;

FIG. 2 is a perspective view of the embodiment of the electrical terminal assembly of FIG. 1;

FIGS. 3A and 3B are perspective views, from two different perspectives, of another embodiment of an electrical terminal assembly according to the present invention;

FIG. 4 is a perspective view of a further embodiment of an electrical terminal assembly according to the present invention; and

FIG. 5 is a perspective view of a dish-like support for an electric heater provided with the embodiment of the electrical terminal assembly of FIG. 4.

### DESCRIPTION OF PREFERRED EMBODIMENTS

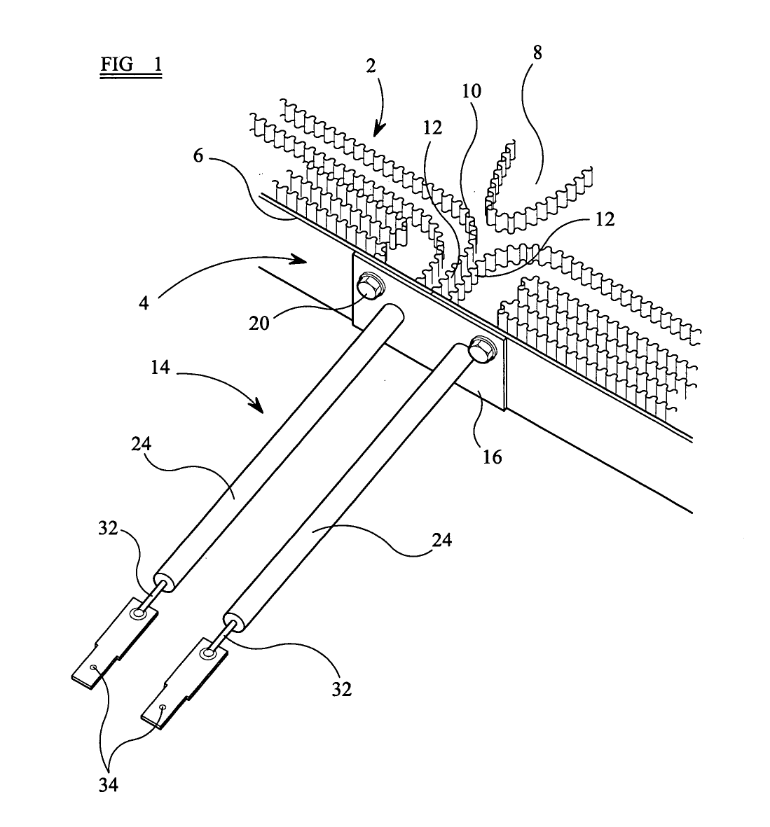

Referring to FIG. 1, a radiant electric heater 2, such as for use in a cooking appliance, comprises a metal dish-like support 4, for example of rectangular or circular shape, having an upstanding peripheral rim 6 and provided with a base layer 8 of thermal and electrical insulation material, such as microporous thermal and electrical insulation material.

At least one radiant electrical resistance heating element 10 is supported relative to the base layer 8. As shown, the heating element or elements is or are in the form of corrugated metal ribbon material, supported on edge on the base layer 8. However, other well-known forms of heating element, or combinations thereof, could be provided.

Termination regions 12 are provided on the heating element or elements 10, and which are arranged to be electrically connected to an electrical terminal assembly 14.

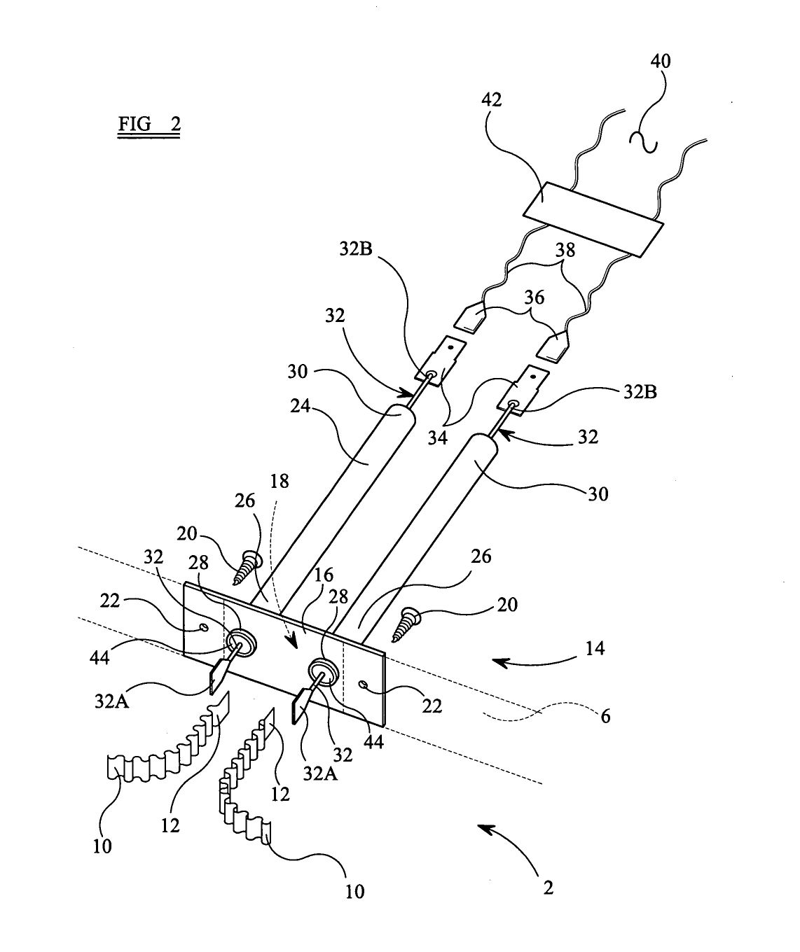

Referring also now to FIG. 2, the electrical terminal assembly 14 comprises abase or attachment member 16, suitably in the form of a metal strip or plate, adapted to be secured to the rim 6 of the dish-like support 4 of the heater 2 at an apertured peripheral region 18 of the rim 6. The attachment member 16 suitably comprises steel, which may be a stainless steel or may be plated with another metal such as copper. The attachment member 16 is suitably secured to the rim 6 of the dish-like support 4 by means of threaded fasteners 20 engaging holes 22 in the attachment member 16 and the rim 6 of the dish-like support 4. Alternatively, the attachment member 16 could be secured to the rim 6 of the dish-like support 4 by rivets or clip means, or by welding or brazing.

Two elongate tubular metal members 24 are provided, having first ends 26 secured in apertures 28 provided in the attachment member 16. Such securing of the first ends 26 of the elongate tubular metal members 24 in the apertures 28 in the attachment member 16 is suitably effected by a welding, brazing or swaging process. The two elongate tubular metal members 24 are arranged to extend outwardly from the rim 6 of the dish-like support 4 of the heater 2 and have second ends 30 at a predetermined distance from the rim 6 of the dish-like support 4 of the heater 2.

Each elongate tubular metal member 24 is provided with an electrically conductive lead member 32 extending through it. The electrically conductive lead members 32 are suitably of metal rod or thick wire form and suitably comprise a ferrous based chromium alloy, a nickel chromium alloy or nickel. The electrically conductive lead members 32 have first ends 32A thereof extending from the first ends 26 of the elongate tubular metal members 24 associated therewith and into the dish-like support 4 of the heater 2. The first ends 32A of the electrically conductive lead members 32 have the termination regions 12 of the heating element or elements 10 directly electrically connected thereto by welding, this operation being assisted by providing the first ends 32A of the electrically conductive lead members 32 of flattened form.

The electrically conductive lead members 32 have second ends 32B thereof extending from the second ends 30 of the elongate tubular metal members 24 associated therewith and are provided with electrical terminal means 34, such as of pin or spade form, which are arranged for interfacing with connectors 36 on external leads 38. Such external leads 38 may be electrically connected to a power supply 40 by way of appropriate control circuitry 42.

The electrically conductive lead members 32 are electrically insulated from their associated elongate tubular metal members 24 by heat-withstanding electrical insulation means 44. Such electrical insulation means 44 is provided within the elongate tubular metal members 24, along the length thereof, between each electrically conductive lead member 32 and its associated elongate tubular metal member 24. The electrical insulation means 44 suitably comprises compacted pulverulent material, which may comprise at least one inorganic oxide material, particularly magnesium oxide. The electrical insulation means 44 is suitably provided by a technique known in the manufacture of metal-sheathed electric heating elements. For example, the electrically conductive lead member 32 is located within its associated elongate tubular metal member 24, the pulverulent insulation material 44 is introduced and the elongate tubular metal member 24 is drawn or rolled to effect compaction of the pulverulent insulation material 44 around the lead member 32.

Alternatively, the electrically conductive lead members 32 may be supported within their associated elongate tubular members 24 by means of a bead of ceramic material of “top hat” configuration inserted into each end of the tubular members. In such a case, electrical insulation is provided by the air between the lead member and the tubular member.

When the electric heater 2 is energised, heat is conducted from the termination regions 12 of the heating element or elements 10 to the first ends 32A of the electrically conductive lead members 32. The length of the electrically conductive lead members 32 and their associated elongate tubular metal members 24 is selected such that the temperature at the second ends 32B of the electrically conductive lead members 32, where the electrical terminal means 34 are provided, is satisfactorily low.

Furthermore, the length of the electrically conductive lead members 32 and their associated elongate tubular metal members 24 can be selected to enable the electrical terminal means 34 to be provided at any desired location relative to the heater 2.

The elongate tubular metal members 24 can be of straight, curved, bent or angled form, as required. They may be arranged substantially parallel to one another, as shown in FIGS. 1 and 2, or at any desired angle or orientation relative to one another.

The electrical terminal assembly 14 of the present invention may comprise a single electrically conductive lead member 32 and its associated elongate tubular metal member 24, secured to the attachment member 16. It may also comprise any desired plurality of electrically conductive lead members 32 and their associated elongate tubular metal members 24, secured to the attachment member 16.

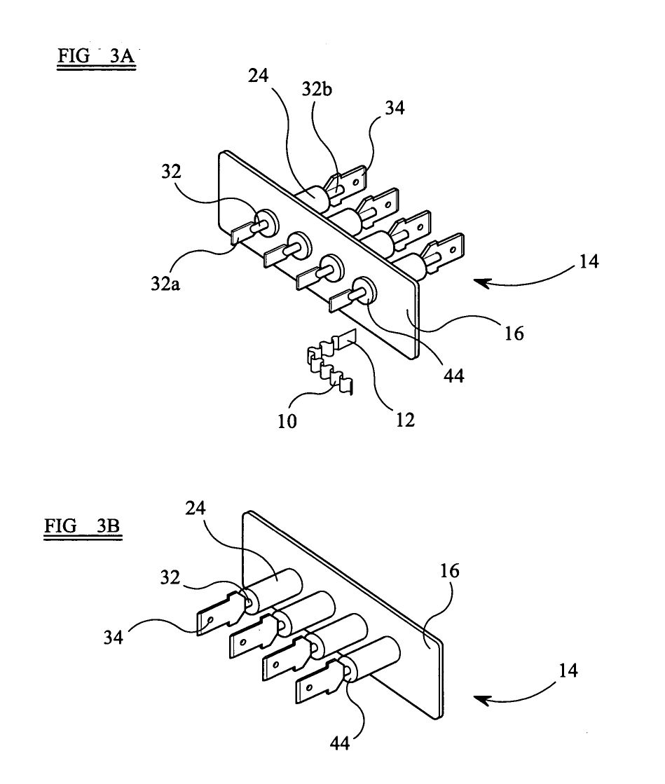

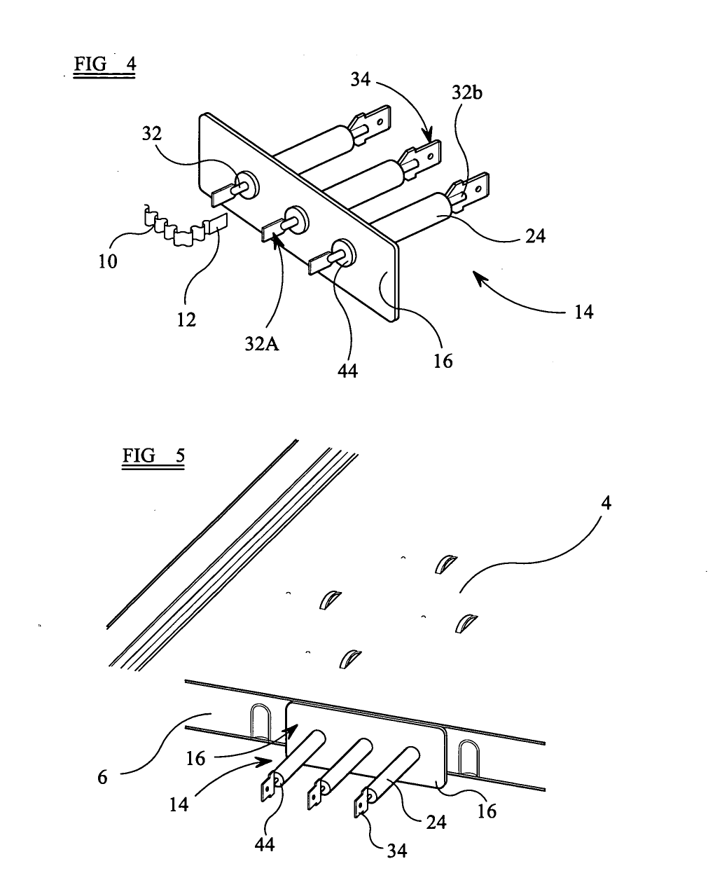

FIGS. 3A and 3B show an electrical terminal assembly 14 in which a side-by-side array of four elongate tubular metal members 24 is provided, of shorter length than the corresponding elongate tubular metal members 24 of FIGS. 1 and 2, and secured to attachment member 16. FIG. 4 shows an electrical terminal assembly 14 in which a side-by-side array of three elongate tubular metal members 24 is provided, secured to attachment member 16. The construction of the assemblies in FIGS. 3A, 3B and 4 is otherwise the same as previously described with reference to FIGS. 1 and 2, including the electrically conductive lead members 32, with first ends 32A thereof for connection to termination regions 12 of heating element or elements 10, and with second ends 32B thereof provided with electrical terminal means 34. As before, electrical insulation means 44 is provided between the electrically conductive lead members 32 and their associated elongate tubular metal members 24.

FIG. 5 shows the electrical terminal assembly 14 of FIG. 4 fitted to apertured rim 6 of a metal dish-like support 4 for an electric heater. Here the attachment member 16 is shown secured to the rim 6 of the dish-like support 4 by welding. It could, however, be secured to the rim 6 by threaded fastener means, in the same way as shown in FIGS. 1 and 2, or by suitable clip means.

1. An electrical terminal assembly comprising: an attachment member adapted to be secured to a support; an elongate tubular metal member of predetermined length, having first and second ends, secured at the first end thereof to the attachment member and extending outwardly therefrom; an electrically conductive lead member extending through the elongate tubular metal member, the electrically conductive lead member having a first end thereof extending from the first end of the elongate tubular metal member, and a second end thereof extending from the second end of the elongate tubular metal member; and heat-withstanding electrical insulation means, in the form of compacted pulverulent material, provided within the elongate tubular metal member between the electrically conductive lead member and the elongate tubular metal member.

2. An electrical terminal assembly as claimed in claim 1, wherein the attachment member is provided with an aperture therethrough for securely receiving the first end of the elongate tubular metal member.

3. An electrical terminal assembly as claimed in claim 1, wherein the attachment member is in a form selected from strip form and plate form.

4. An electrical terminal assembly as claimed in claim 1, wherein the elongate tubular metal member is secured at the first end thereof to the attachment member by means selected from welding, brazing and swaging.

5. An electrical terminal assembly as claimed in claim 1, wherein the pulverulent material comprises at least one inorganic oxide material.

6. An electrical terminal assembly as claimed in claim 5, wherein the at least one inorganic oxide material comprises magnesium oxide.

7. An electrical terminal assembly as claimed in claim 1, wherein the electrically conductive lead member is supported within the elongate tubular metal member by means of a bead of ceramic material.

8. An electrical terminal assembly as claimed in claim 7, wherein the bead of ceramic material is of “top hat” form and inserted into each end of the tubular member.

9. An electrical terminal assembly as claimed in claim 1, wherein the electrically conductive lead member is of a form selected from metal rod and thick wire form.

10. An electrical terminal assembly as claimed in claim 9, wherein the electrically conductive lead member is selected from a ferrous based chromium alloy, a nickel chromium alloy and nickel.

11. An electrical terminal assembly as claimed in claim 1, wherein the first end of the electrically conductive lead member is of flattened form.

12. An electrical terminal assembly as claimed in claim 1, wherein the second end of the electrically conductive lead member is provided with electrical terminal means.

13. An electrical terminal assembly as claimed in claim 12, wherein the electrical terminal means is of a form selected from pin form and spade-like form.

14. An electrical terminal assembly as claimed in claim 1, wherein the elongate tubular metal member is of a form selected from straight, curved, bent and angled form.

15. An electrical terminal assembly as claimed claim 1, wherein a plurality of the elongate tubular metal members are provided.

16. An electrical terminal assembly as claimed in claim 15, wherein the elongate tubular metal members are secured in side-by-side arrangement to the attachment member.

17. An electrical terminal assembly as claimed in claim 15, wherein the plurality of the elongate tubular metal members are disposed substantially parallel to one another.
